(19) United States
(12) Patent Application Publication
(10) Pub. No.: US 2002/0041723 A1
(43) Pub. Date: Apr. 11, 2002

(54) Multi-parameter fiber optic probes

(76) Inventors: Erlend Ronnekleiv, Trondheim (NO); Jon Thomas Kringlebotn, Trondheim (NO); Dag Roar Hjelme, Trondheim (NO)

Correspondence Address: Marina F. Cunningham, McCormick, Paulding & Huber LLP, CityPlace II, 185 Asylum Street, Hartford, CT, 06103-3402, US

(21) Appl. No.: 09/948,427

(22) Filed: Sep. 7, 2001

(30) Foreign Application Priority Data
Sep. 7, 2000 (GB) 0021976.6

(51) Int. Cl. G02B 6/26; G02B 6/34

(52) U.S. Cl. 385/12; 385/37

(57) ABSTRACT

A body compatible fiber optic sensor probe is provided. The probe includes at least one optical fiber and the fiber or fibers include at least one sensing region adapted and arranged such that the probe has simultaneously measurable respective optical properties that are responsive to respective different parameters within the body, such properties being dependent upon mechanical strain established in the fiber or fibers in response to said parameters. Such a probe is suitable for invasive medical use.

This application is entitled to the benefit of, claims priority from, and incorporates by reference subject matter disclosed in UK Patent Application No. 0021976.6, filed on Sep. 7, 2000.

This invention relates to fiber optic probes and sensors, particularly but not exclusively for invasive medical applications used in the measurement of at least one parameter within the body. These parameters (measurands) include pressure, differential pressure, radiation, fluid flow, temperature, and biological parameters such as concentration of particular chemical and biological substances at one or a number of measuring locations within the body. The invention also extends to methods of medical treatment and diagnosis which employ the fiber optic probes of the invention. Whilst some aspects of the invention relate to invasive medical applications, features and aspects of the probes may also find application in other measuring contexts, such as ex-vivo or in vitro medical uses.

With the advance of technology relating to medical diagnosis and therapy there is an on-going need to improve methods and systems for sensing various physical, chemical and biological parameters within the body. Such sensing is needed both during diagnosis and during treatment. Further, there is increasing emphasis on the use of minimally invasive medical techniques, intended to reduce the trauma to the patient during and following medical procedures. In this respect, given their small dimensions, fiber optic devices are commonly used in various aspects of medicine, for example for viewing a treatment site via an endoscope, for delivery of laser therapy within the body, and in the context of optical biochemical sensor probes for monitoring and measuring various parameters.

A variety of prior art biochemical sensors for medical use are known, and they generally include a coating or reagent provided on the end face of a waveguide provided at or defined by the end of an optical fiber. The coating or reagent material reacts with interrogating light in order to provide a change in optical response of the detector. The sensing mechanisms may be chemical systems whose spectra change under the effect of particular reactions, or dielectrics which change refractive index through induced swelling or another mechanism.

These known sensors operate through direct interaction between the reactant coating and the interrogating light, which leads to certain practical disadvantages, and are generally configured to be responsive to only a single parameter within the body to be measured, for example a particular chemical or biological substance. It is an object of the invention to provide an improved fiber optic sensor probe for invasive medical use.

A first aspect of the invention provides a body compatible fiber optic sensor probe for invasive medical use, such probe including at least one optical fiber, the fiber or fibers having at least one sensing region adapted and arranged such that the probe has simultaneously measurable respective optical properties responsive to respective different parameters within the body, such properties being dependent upon mechanical strain established in the fiber or fibers in response to said parameters.

Preferably, the sensing region comprises a mass of reactive material configured to create mechanical strain within the fibre in such a way as to change its optical response.

Preferably, the probe enables the simultaneous measurement and quantification of two or more different parameters in use. Alternatively, only a first parameter may be measured and quantified, with the measurement of a second parameter being used to correct the measurement of the first parameter in relation to variations in optical properties caused by the second parameter which might otherwise interfere with the measurement and quantification of the first parameter.

Such a probe represents a new departure from known medical fiber optic probes in that more than one parameter can be measured simultaneously by a single probe in a design of probe in which the detectable optical properties are dependent on strain established in the fiber or fibers. In such a probe there need be no direct interaction between the interrogating light and a reactant material as is the case with most prior art medical probes. These parameters or measurands include pressure, radiation, fluid flow, temperature, and biological parameters such as antibodies, pathogens etc., and/or chemical parameters such as dissolved blood gases, electrolytes, glucose etc.

A medical probe according to the invention preferably has one optical property which changes in accordance with a first parameter, and a further, different optical property which changes in accordance with a second parameter, such that through the use of a suitable interrogation system each parameter can be measured independently.

The invention extends to sterile probes of the type described above and below, and to sterile packs including such probes.

The invention also provides methods of treatment or diagnosis of the human or animal body using any of the probes described herein.

Viewed from a further aspect the invention provides a method of treatment or diagnosis of a human or animal body, which involves the simultaneous sensing of different parameters within the body through the use a fiber optic probe having a sensing region or regions with measurable optical properties dependent on mechanical strain established in one or more optical fibers wherein the probe is responsive to at least two different parameters within the body. Preferably, two or more parameters are simultaneously measured and quantified.

Various general configurations of probe design in accordance with the invention are envisaged. In one set of embodiments the probe comprises a tubular housing, which contains therewithin a portion of the or each optical fiber, and is arranged such that the fiber, in the sensing region(s) thereof, is exposed to the parameter to be measured.

In a preferred such embodiment the probe consists of two or more fibers arranged side-by-side within the housing, these fibers having respective sensing regions which are responsive to different parameters or measurands. Such an arrangement represents a new departure from known fiber optic sensors.

Viewed from another aspect, therefore, the invention provides a fiber optic sensor device, which comprises a housing mounting therewithin at least two optical fibers mounted side-by-side, these fibers including respective sensing regions responsive primarily to respective different parameters to be measured.

As discussed below, the housing is constructed such that the fibers are suitably exposed to the different measurands in the sensing regions thereof.

Additionally or alternatively, one or more fibers can be provided with sensing regions responsive primarily to different parameters at axially spaced locations along the fiber length. In such a probe, only a single optical fiber needs to be provided, though multiple fiber probes are also possible, with each fiber having multiple sensing regions.

A further aspect of the invention therefore provides a body compatible fiber optic sensor probe for invasive medical use, such a probe including at least one optical fiber having axially spaced sensing regions, these regions providing in use distinguishable optical responses or outputs dependent primarily on different parameters within the body.

In such an embodiment, the optical fiber or fibers may again be located in a suitable, body compatible protective housing.

In certain embodiments of the invention, one of the parameters to be detected is fluid pressure within the body. In such an arrangement, an optical fiber is configured in at least one sensing region to provide a changing optical property depending on the pressure applied to the fiber. Optical fiber pressure sensors are known in other contexts, as will be described below.

In a preferred embodiment of the invention in which the fiber or fibers of the probe are mounted within a protective tubular housing, such housing may be filled with a liquid or gel such that external pressure applied to the probe housing is transmitted to the surface of a pressure sensitive region of the optical fiber within the housing. In one such embodiment, the protective housing includes an aperture or apertures covered by a flexible membrane, through which external pressure is transmitted to the liquid or gel contained within the housing and thereby is applied to the optical fiber. The use of a gel or liquid interposed between the or each fiber and the probe outer housing is advantageous in that, as well as pressure, other physical, biological or chemical parameters to be measured can be transferred to sensing regions of the fiber or fibers within the housing.

For example, a particular embodiment of the invention includes a temperature sensing region as well as a pressure sensing region within one or more optical fibers. Through the use of a liquid having good thermal conductivity, it will be appreciated that both pressure and temperature can be transferred from the environment outside the probe housing to the or each optical fiber within the housing via the liquid contained therein. In this embodiment, the probe housing, as well as including a pressure translating membrane, should be formed of a material of good thermal conductivity.

Further, in the case of a biological or chemical sensor, a liquid or gel within the housing provides a convenient means whereby particular molecules to be sensed can diffuse through the liquid and thereby be transferred to one or more optical fibers located within the housing, such fiber(s) having a suitable reactive sensing element coupled to the fiber whereby a change in optical response is obtained.

A further aspect of the invention provides an optical fiber sensor device which includes a sealed tubular housing containing therewithin at least one optical fiber having at least one sensing region, there being a liquid or flowable gel disposed within the housing and surrounding the fiber, the liquid or gel permitting the transfer of at least one parameter to be measured from a region outside the housing to a sensing region of the fiber.

As discussed, the or each parameter transferred by the liquid can be any of pressure, temperature, or biological or chemical substances which can diffuse through the liquid or gel.

A suitable liquid is isotonic saline.

The housing may include one or more apertures covered by a membrane, the membrane allowing the application of pressure to the liquid or gel from the surrounding environment and/or allowing the selective diffusion of molecules to be sensed through the membrane.

In a multi-parameter sensitive probe according to the invention, the probe has changeable and detectable respective optical properties responsive to different parameters. These “respective optical properties” can in fact be the same general fiber property, but provided in different fibers of the probe which are configured to render the properties responsive to different parameters.

Hence, the optical output from two fibers may be generally the same, but the variation in these outputs would vary differently in response to different measurands.

In preferred embodiments of the invention, however, different and distinguishable optical properties of a particular fiber, or of respective fibers, are responsive, at least primarily, to respective parameters to be measured. This enables the more convenient use of a single fiber for measurement of different parameters through the use of differently responsive sensing regions. These different optical properties can, for example, be spectral peaks or troughs at different wavelengths, whose respective wavelength shifts are responsive to different parameters within the body.

In a particularly preferred embodiment, one optical property of the sensor probe is the absolute wavelength of one or more spectral peaks of the fiber's optical response, and a further optical property is the spacing between spectral peaks or troughs in the mutually orthogonal polarization planes of the fiber. Through the use of suitably calibrated and known interrogation means, these properties can be measured independently and, according the invention, are preferably primarily responsive to different body parameters.

The required optical properties of the fiber at the or each sensing location can be provided by various known methods. For example, the sensing regions of the fiber may be configured to provide a form of “Fabry-Perot” (F-P) interferometer, whose output wavelength when interrogated by a suitable light source depends on longitudinal stress applied to the fiber. In such a system there are in effect spaced “mirrors” within the fiber whose spacing determines the output wavelength which therefore changes with longitudinal strain within the fiber.

Alternatively, the sensing regions can be based on active or passive fiber Bragg gratings (FBG's) written into the optical fiber core. These gratings are made by producing periodic variations in the refractive index along a short section in the core of an optical fiber, and methods for fabricating such gratings are generally known in the art. Passive FBG devices, and interrogating systems therefor, are known for example from U.S. Pat. No. 5,828,059 and WO 98/36252. In U.S. Pat. No. 5,828,059, a fiber is adapted to sense both radial pressure and longitudinal strain. The radial pressure is sensed through the use of an FBG in the region of a fiber provided with side air holes either side of the core. Radial stress applied to such a fiber will cause a change in the birefringence of the fiber and a detectable change in the spacing between the spectral peaks of the reflected light in mutually orthogonal polarization planes. The absolute wavelength of the peaks depends on the grating spacing, and is therefore responsive to temperature, which causes longitudinal contraction/expansion of the fiber. The change in birefringence is less sensitive to temperature changes. Hence, such a sensing arrangement is particularly suitable for use in a medical probe according to the invention used for multi-parameter measurements.

A further preferred sensing method used for the probes of the present invention involves the use of active fiber lasers, particularly active FBG lasers. Such devices for use in fiber optic sensors are described, for example, in U.S. Pat. No. 5,844,927 and U.S. Pat. No. 5,564,832. In such systems, an end-pumped fiber laser with distributed feedback (DFB) oscillates on two orthogonally polarized wavelengths. Again, the distance between these wavelengths may be tuned by changing the birefringence of a fiber, and therefore can be pressure sensitive. The absolute wavelength of each peak is responsive to longitudinal strain, and hence is responsive to temperature, for example. The aforementioned prior art references each describe suitable interrogation systems for detecting fiber outputs which are suitable for use in the present invention. These involve suitable laser light sources, and spectral analysis systems of generally known types.

In embodiments of the invention, a DFB laser, consisting of a single FBG written into a rare-earth doped optical fiber, can be used. Alternatively, a fiber DBR (distributed Bragg Reflector) laser can be used. As is well known, these fiber lasers are pumped from one end by a semi-conductor laser, and oscillate to provide the detectable optical properties or output of the sensor. The distal end of the fiber is generally terminated at a cleaved end to prevent back reflections at the fiber laser wavelength, and may also be provided with a suitable pump reflector, such as a passive FBG at the pump wavelength to prevent residual pump light exiting from the fiber end, which could cause heating.

Optical fiber probes according to the invention can incorporate one or more of the above optical systems whereby the changeable optical properties responsive primarily to different parameters are obtained.

The fiber sensing regions can be rendered responsive to various parameters by different means. In a preferred embodiment, at least one sensing region comprises a sensing element formed of a material which undergoes a change in volume upon exposure to a parameter to be measured, such change in volume creating a strain within the fiber whereby a detectable change in optical response is obtained.

In those embodiments discussed above including a passive or active fiber Bragg grating in a birefringent fiber, the sensing element may cause longitudinal strain, bonding strain, and/or generally radially directed strain, so that there is a change both in the absolute wavelength of the optical response or output of the fiber, and a change in the distance between the spectral peaks in mutually orthogonal polarization planes.

A particularly convenient form of sensing element is in the form of a coating of reactive material provided on the fiber. Such a coating may be configured to apply longitudinal and/or radial strain upon swelling when exposed to a measurand.

A birefringent fiber may be a side-hole fiber, a D-fiber, a Bow-Tie fiber, or a Panda fiber, or another fiber with special geometry which establishes a change in birefringence upon sideways pressure.

It is also possible to provide the sensing element in one or more side-holes of the fiber, such that when exposed to a measurand, the element swells and causes distortion of the fiber and establishes a change in birefringence.

Alternative forms of sensing element include, for example, suitable piston and cylinder arrangements, in which a sensing element expands to provide a longitudinal strain within the fiber which in turn changes the detectable optical response. These and other possible probe arrangements are described in our co-pending patent application entitled “Fiber Optic Probes” lodged simultaneously herewith.

Where one or more fiber sensing regions of a probe according to the invention is provided with a sensing element arranged to create mechanical strain in the fiber and alter its optical properties, the sensing element can comprise a variety of materials depending on the measurand to be detected. The reactive material consists of or is provided with an indicator which indicates the presence of the measurand and determines its concentration (in the case of a chemical/biological sensor) or magnitude (in the case of a pressure, radiation or temperature sensor). The material should be highly sensitive in that it should undergo a large volume change for relatively low concentrations or magnitudes of the parameter to be measured, so that a strain is applied to the fiber creating a readily detectable change in optical response.

Preferred reactive materials may be reactive to non-ionizing radiation, ionizing radiation and chemical or biological, including immunological, interactions.

In certain embodiments of the invention, the reactive material of the sensing element is immobilized on a solid support medium, such as a polymer, copolymer, or various glasses. The immobilization method can be mechanical, electrostatic or chemical. The support medium can remain inert to the reaction being analysed, although in some embodiments it is envisaged that the support could also itself act as a selective element, for example through controlled porosity, to enhance the selectivity of the sensor, and to protect the active medium of the sensor element.

In other embodiments of the invention, for example where the sensing element is located in a cylinder, or within the side-holes of a fiber, it is envisaged that the reactive material of the sensing element could be dispersed or immobilized in a fluid or gel, which swells or contracts in response to a target measurand in order to apply the required stress to the fiber.

In all cases, a separate body compatible membrane covering or enclosing the sensing element can be provided to enhance selectivity of the sensor and protect the active part of the sensor. This membrane can provide selectivity based on size selectivity of the measurand species through controlled porosity of the membrane, chemical/biochemical selectivity through chemical reactions, or ionic selectivity through electrostatic interactions.

In the case of the coating embodiments, the coating can conveniently be made from a form of paint or bonding material, a polymer gel material, or from a porous material, such as a sol-gel glass or ceramics, to make an open matrix configuration. A further example of a suitable material for use as the sensor is micro-spherical balls, with additives to generate chemical selectivity for a selected group of molecules. Such balls can be confined, for example, within a piston and cylinder, or within a membrane.

One preferred sensing element comprises ionic N-Isopropylacrylamide (NIPA) polymer gel copolymerised by sodium acrylate (SA) which is known to exhibit substantial swelling in an ionic solution. This swelling is a result of an increased osmotic pressure within the gel due to mobile counter ions to the bound cations. As described, for example, in U.S. Pat. No. 5,744,794, hydrogel materials can be formulated of numerous other types and consistencies, and can be prepared to respond to different external stimulii. Those skilled in the art will recognise that hydrogel materials can be formulated to respond to a variety of in body parameters and therefore are particularly suited for use in the sensor probes of the present invention.

The swelling behaviour of polymer gel networks is governed not only by the affinity of polymer chains for solvents, as in the NIPA-SA gel example, but also by the cross-linking density, (see for example M. Shibayama and T. Tanaka, “Volume phase transitions and related phenomena of polymer gels,” in Advances in Polymer Science, vol. 109, Springer Verlag, 1993). The cross-linking density controls the elastic restoring force. Affecting the elastic restoring force in turn affects the equilibrium swelling volume of the gel network.

Polymer gel networks responsive to specific biochemicals can therefore also be prepared by application of stimuli-sensitive complex formation at cross-linking points in the gel network, e.g. application of antigen-antibody binding at cross-linking points.

One way to synthesize such materials is to use the well-known polyacrylamide gel system (PAAm) and including the functionalized recognition molecule in the cross-link-co-polymerization reaction. An example of this is described by T Miyata et al., “A reversibly antigen-responsive hydrogel,” Nature, vol. 399, pp.766-769, 1999, who used the polyacrylamide gel system to conjugate IgG antibody to prepare an antigen-responsive gel. More specifically they used rabbit immunoglobulin G (rabbit IgG) and goat anti-rabbit IgG (GAR IgG) as the antigen and antibody. Competitive binding of the free antigen (analyte) break the antigen-antibody (receptor) cross-link, thereby reducing the cross-linking density and triggering a change in gel volume.

There are numerous other antigen-antibody or other specific biochemical “key-lock” pairs that can be selected for such biochemical sensitive polymer gel networks, e.g. biotin-avidin and various lectin-saccharide pairs. Any of these can be used to provide the sensing elements of the present invention.

In a preferred embodiment of multi-parameter detecting probe, the probe consists of a tubular housing mounting therewithin in side-by-side arrangement two or more optical fibers, at least one of such fibers being provided with a sensing element responsive to a first parameter to be measured, and another fiber being absent such sensing element, or provided with a different sensing element to detect a different parameter.

Where the second fiber is absent the sensing element, the optical response from this fiber may be used to correct the output from the fiber provided with the sensing element for changes in temperature, for example, which might otherwise interfere with the accurate measurement of a chemical of physical parameter detected by the sensing element.

Viewed from a further aspect, the invention provides a fiber optic sensor device comprising a tubular housing mounting therewith optical fibers in side-by-side relation, a first fiber providing a birefringent response dependent on pressure applied to the fiber, and the second fiber providing a temperature dependent response which may be used to correct measurements based on the optical output of the first fiber.

The pressure responsive fiber may be provided in the or each sensing region thereof with a reactive coating as described above, which swells in response to a particular measurand. Alternatively or additionally, a pressure responsive fiber may be arranged to be responsive to the pressure outside the probe.

A further embodiment of the invention includes three fibers extending along a probe housing. A first fiber has at least one pressure sensitive region provided with a reactive coating; a second fiber has at least one pressure sensitive region but not provided with the reactive coating; and the third fiber is responsive only to longitudinal strain. The fibers each have like FBGs or other sensors, in their sensing regions. In this way, a single probe may be used to measure, for example, chemical or biochemical parameters, pressure, and temperature. Further, the output from the temperature sensor may be used to correct the measurements of the other two parameters.

In such multiple fiber arrangements, the distal ends of the fibers can be connected via a fiber minibend device, such as described in U.S. Pat. No. 5,452,393, which couples light between the fibers. In this way, pumping light may be passed only through one fiber, and is reflected at the free end so as to be passed through lasers in both fibers (where the detecting system comprises active fiber lasers).

In all embodiments of the invention, several sensing regions can be placed in series along one or multiple fibers for distributed measurements, in which case the detecting systems along the same fiber should have non-overlapping wavelengths. The outputs from these can be multiplexed using known means.

Viewed from a further aspect the invention provides a fiber optic sensor device, comprising a fiber or fibers having respective sensing regions located within a sealed tubular housing containing a liquid interposed between the sensing regions and the wall of the housing, a first sensing region being primarily pressure dependent, and a second sensing region being primarily temperature dependent.

Certain embodiments of the invention will now be described, with reference to the accompanying drawings, wherein:

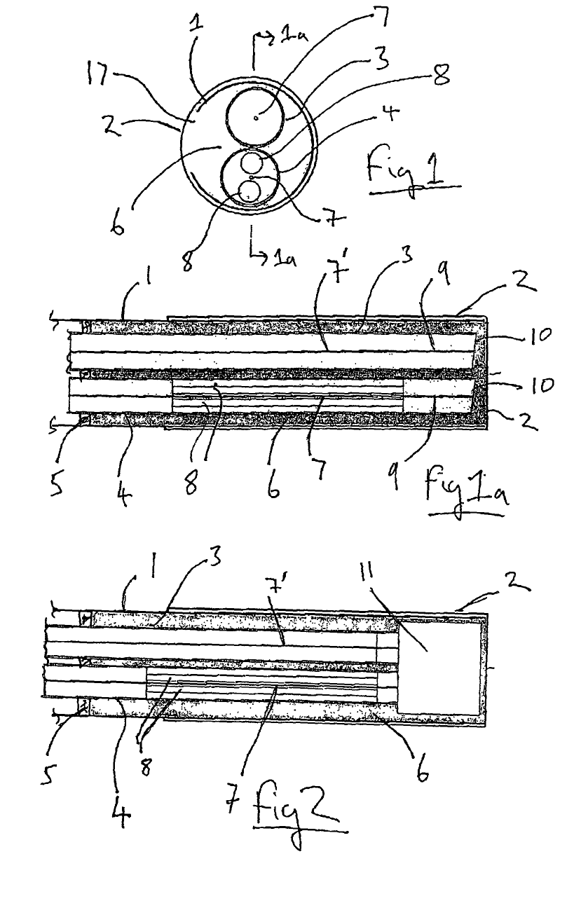

FIG. 1 is a partly schematic transverse cross-section through part of the distal end of a first embodiment of fiber optic probe for invasive medical use in accordance with the invention;

FIG. 1a is a longitudinal cross-section of the probe, again partly schematic, taken along line 1a-1a in FIG. 1;

FIG. 2 is a view similar to FIG. 1a, showing a modified embodiment;

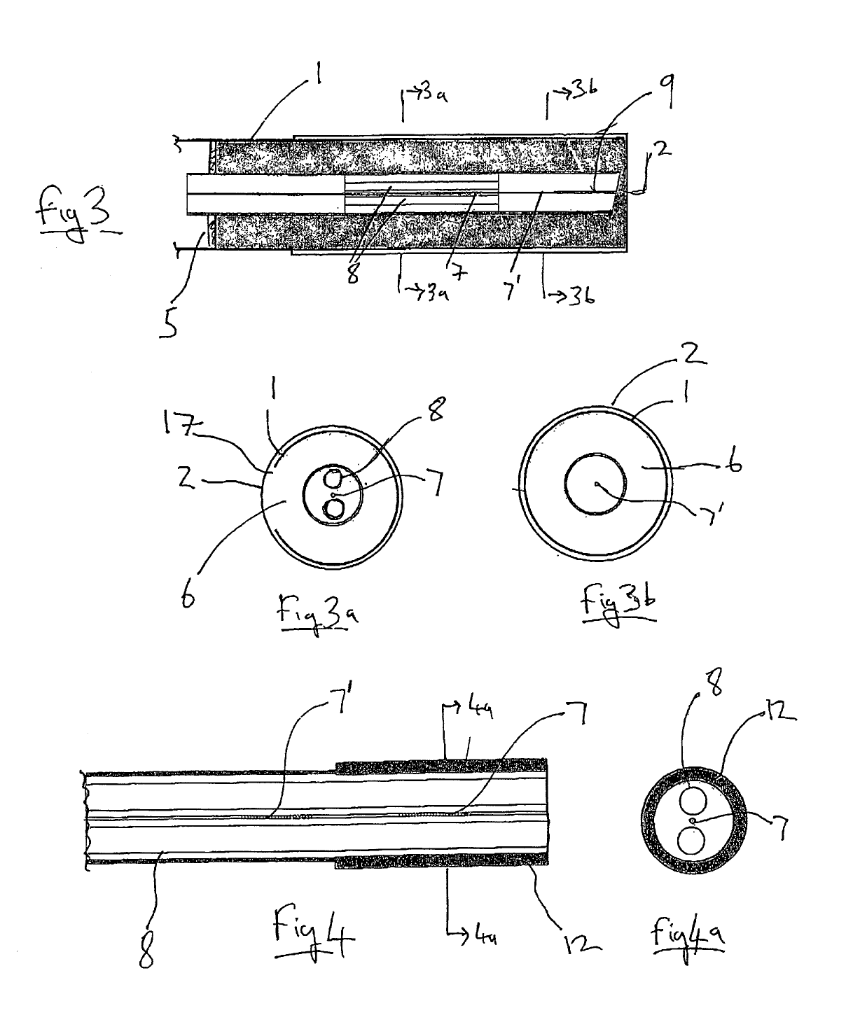

FIG. 3 is a longitudinal cross-section illustrating a further embodiment of the invention;

FIGS. 3a and 3b are transverse cross-sections taken respectively along lines 3a-3a and 3b-3b in FIG. 3;

FIG. 4 is a longitudinal cross-section through a further probe according to the invention;

FIG. 4a is a transverse cross-section taken along line 4a-4a in FIG. 4;

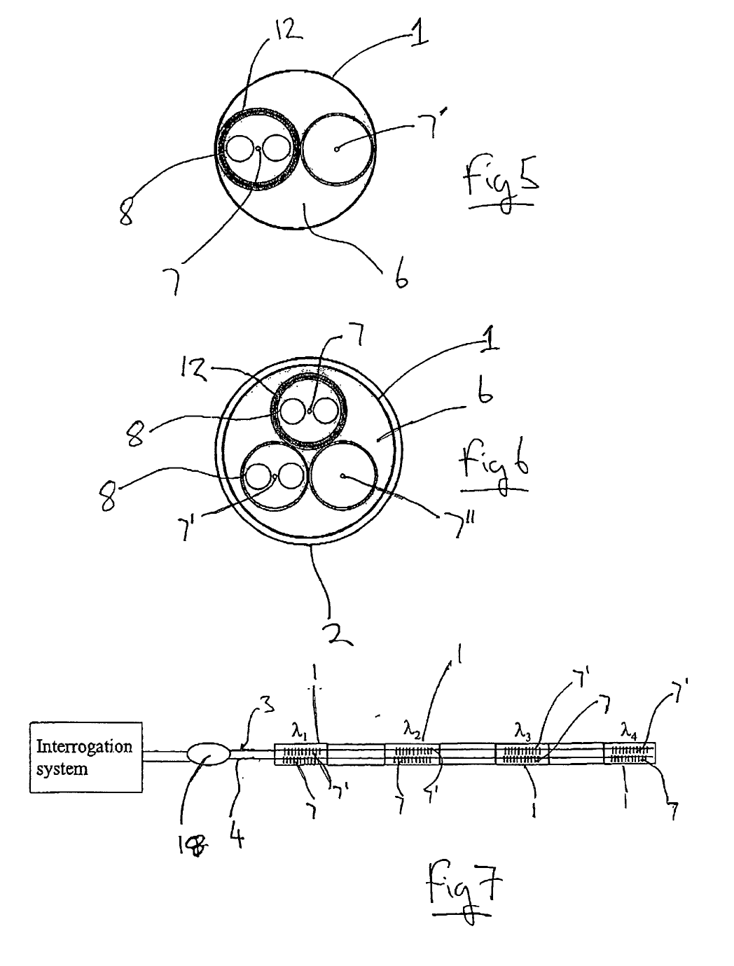

FIGS. 5 and 6 are transverse cross-sectional views illustrating further embodiments of probe; and

FIG. 7 shows, schematically, an interrogation system coupled to a probe according to the invention having a multiplicity of axially spaced sensing regions.

Referring to the drawings, in which like reference numerals are used to indicate the same or similar or components in the various embodiments, FIGS. 1 and 1a illustrate a first embodiment of probe according to the invention. This is adapted for pressure and temperature sensing. The probe comprises a tubular housing 1 of a rigid body-compatible polymeric material, or of a suitable ceramic, metal or glass material, typically having a diameter of the order of 1 to 2 mm. The housing is covered by a flexible membrane 2, of a suitable body-compatible resilient material.

Mounted within the housing 1 are two optical fibers 3, 4. An end portion of the housing is closed by a seal 5 of a suitable resilient material, having apertures through which the fibers extend. The sealed end region of the housing is filled with a liquid 6, such as saline.

The tube 1 includes a split or aperture 17 midway along its length, which enables the pressure of the environment surrounding the probe to be applied to the liquid 6 within the probe housing.

As shown in Figure 1a, the axial end of the housing is also open, so that the membrane 2 encloses this end. Thus, pressure is also applied to the liquid within the housing via the open end of the housing.

It will be appreciated that the split 17 shown in FIG. 1, and the open end in Figure 1a represent alternative means whereby external pressure can be applied to the liquid. These can be used independently or together.

In the preferred embodiment each fiber 3, 4 comprises a sensing region 7, 7′ in the form of dual-polarization fiber DFB FBG lasers, or two passive birefringent _-phase-shifted FBGs, which are arranged in parallel, a first located 7′ in the fiber 3 and a second 7 located in the fiber 4. The fiber 4 is provided with two side-holes 8 in the vicinity of the FBG sensing region 7.

Through the use of a suitable pumping and interrogation system, such as that described either in U.S. Pat. No. 5,844,927 or U.S. Pat. No. 5,564,832, the optical outputs from the fiber laser sensing devices can be measured to provide an indication both of pressure and temperature in the probe environment. The side-hole fiber 4 provides a birefringent optical output, whose spectral peaks in mutually orthogonal polarization planes are spaced by an amount depending on the pressure applied to the fiber in the region of the side-holes. Since the outside pressure is applied to the fiber via the liquid 6, measurement of this wavelength spacing can provide an accurate pressure measurement.

The fiber 3 which is not provided with side-holes is not responsive to pressure. However, both fibers provide an output whose wavelength depends on temperature. This is because the wavelength of the fiber lasers depends on the FBG spacing within the devices which in turn depends on longitudinal extension of each fiber. This changes with temperature because of the fiber's natural coefficient of thermal expansion. Hence, the optical output from the fiber 3 can be used to obtain a temperature measurement, and/or can be used to correct the output from the fiber 4 for temperature variations.

It will be appreciated that the use of a sensor probe containing a liquid whereby pressure and temperature is uniformly applied to the fibers provides a convenient means for transferring these parameters to the fibers without the need for the body fluids to directly engage the fiber surfaces. This is particularly advantageous in the case of a body implantable probe, in which it is desirable to provide a tubular sleeve over the multiple fibers for ease of insertion into the body and for cleaning and disinfecting, but in which good pressure and thermal transfer to the fibers within the housing is required.

In the illustrated embodiment, each of the fibers 3, 4 further includes a FBG pump reflector 9 to prevent the interrogating light heating the end of the probe, and the free end face 10 of the fiber is cleaved.

The interrogation of the birefringence of the fiber laser sensors can be based in a known manner on the electrical beat frequencies between the optical laser frequencies in mutually orthogonal polarization planes, as again described in U.S. Pat. Nos. 5,564,832 and 5,844,927.

Alternatively, the sensing regions 7, 7′ can be passive FBG devices, which are interrogated in a manner described, for example, in U.S. Pat. No. 5,828,059 and U.S. Pat. No. 6,097,487.

An alternative embodiment is shown in FIG. 2. This is similar to the embodiment shown in FIG. 1, but shows the two fibers 3, 4 spliced together via a fiber minibend device 11, of a type produced by Aster and described in U.S. Pat. No. 5,452,393. This device couples the light between the two fibers, such that the fiber can be pumped through only one of the fibers, and light is passed to both FBG sensing regions 7, 7′. This arrangement avoids the need for splitting a pump laser of the interrogating device into two beams, and also avoids the needs for the pump light reflectors 9.

An alternative embodiment is shown in FIGS. 3, 3a and 3b. This embodiment is generally similar to that shown in FIG. 1, except that the two sensing regions 7, 7′ are spaced axially in relation to the same optical fiber 4. Hence, there is a first passive or active FBG device 7 arranged in a region of the fiber 4 having side-holes 8. A second FBG device 7′ is located in an axially spaced region of the same fiber which is not provided with the side-holes. As in the first embodiment, therefore, the change in birefringent response from the laser 7 is responsive primarily to pressure, whereas the change in absolute wavelength of each sensor 7, 7′ is temperature dependent.

In practice, the sensing regions of the fiber 4 are formed as separate components and spliced together.

A further embodiment of the invention is shown in FIG. 4. In this embodiment, a fiber having side-holes 8 and respective passive or active FBG devices 7, 7′ is provided with a sensing element in the form of a reactive coating 12 which expands/contracts in response to a specific measurand, which can be, for example, chemical or biological concentrations, or an electromagnetic field. Examples of the coating material are discussed above.

The output from the FBG device 7 therefore varies in response to radial and longitudinal strain in the fiber resulting from swelling of the coating 12 on exposure to a particular measurand. Again, the birefringence of the fiber, i.e. the spacing between the spectral peaks in different polarization planes, is primarily dependent upon the radial pressure applied by the coating. The absolute wavelength of these peaks is dependent on the longitudinal strain. Depending on the nature and thickness of the coating, the strain applied to the fiber in response to a particular measurand will vary, and the interrogating system (not shown) can be calibrated accordingly.

The embodiment in FIG. 4 includes a further sensing element 7′, which is spaced from the coating 12. This may be used, for example, for temperature measurements, or to compensate the output from the sensor 7 for variations in temperature which might otherwise interfere with measurements of strain applied by the coating 12.

FIG. 5 shows a cross-section through a further embodiment, which again includes a tubular housing 1.

Two optical fibers, a first having side-holes 8, and a second without side-holes are located side-by-side within the housing. Each is provided with an active or passive sensor device 7, 7′. The side-hole fiber includes a reactive coating 12, which again expands or contracts in response to a particular measurand. In this case, the housing 1, in the case of a chemical or biological sensor, may allow the ingress of molecules to be sensed. A liquid 6 provided within the housing may allow the diffusion of molecules to be sensed through the liquid so that they impinge on the reactive coating 12.

The sensor 7′ provides an output which is temperature dependent, and may be used for separate temperature measurements and/or to compensate measurements from the sensor 7 in the side-hole fiber for temperature variations.

A further embodiment is shown in FIG. 6. In this embodiment, three fibers are mounted side-by-side, each with a respective active or passive FBG sensor 7, 7′, 7″. These are mounted within a rigid housing 1, covered by a flexible membrane 2. An aperture in the side or end wall of the housing 1 enables the external pressure to be transmitted to the fibers via the liquid 6.

A first side-hole fiber having sensor 7 is provided with a reactive coating 12, responsive to a particular chemical or biological measurand, which again may diffuse through the housing 1, membrane 2 and liquid 6. A second side-hole fiber having sensor 7′ is responsive to pressure applied via the liquid 6. The third fiber having sensor 7″ is temperature sensitive.

Hence, multiple parameters can be measured by this probe, or measurements of one parameter can be used to correct measurements of a different parameter.

FIG. 7 shows, schematically, a distributed sensing system, in which a series of birefringent fiber sensors 7, 7′ are contained in pairs in respective probe housings 1, which may be of the general form described in the earlier embodiments. The two fibers 3, 4 are spliced to the output ports of a polarization maintaining coupler 18. This system can be used to measure two or more parameters at a number of different axial locations along the probe. The FBG devices within the respective housings 1 operate on different wavelengths so that their outputs can be monitored independently through the use of a suitable multiplexing system.

1. A body compatible fiber optic sensor probe for invasive medical use, the probe including at least one optical fiber, the fiber or fibers including at least one sensing region adapted and arranged such that the probe has simultaneously measurable respective optical properties responsive to respective different parameters within the body, such properties being dependent upon mechanical strain established in the fiber or fibers in response to said parameters.

2. A probe as claimed in claim 1 wherein the at least one sensing region comprises a mass of reactive material configured to create mechanical strain within the fiber in such a way as to change its optical response.

3. A probe as claimed in claim 1 comprising one or more fiber Bragg gratings (FBG's) written into the optical fiber core.

4. A probe as claimed in claim 1 comprising an active fiber laser including said fiber.

5. A body compatible fiber optic sensor probe for invasive medical use, the probe including at least one optical fiber, the fiber or fibers including at least one sensing region adapted and arranged such that the probe has simultaneously measurable respective optical properties responsive to respective different parameters within the body, such properties being dependent upon mechanical strain established in the fiber or fibers in response to said parameters, said fiber comprising a pair of pi phase-shifted fiber Bragg gratings.

6. A probe as claimed in claim 1 wherein the fiber has a fiber length, said one or more fibers being provided with sensing regions responsive primarily to different parameters at axially spaced locations along the fiber length.

7. A probe as claimed in claim 1 wherein the probe is configured to measure first and second parameters, quantify said first parameter and use the measurement of the second parameter to correct the measurement of the first parameter.

8. A probe as claimed in claim 1 having a first optical property which changes in accordance with a first parameter, and a second optical property different from the first which changes in accordance with a second parameter, such that through the use of a suitable interrogation system said first and second parameters can be measured independently.

9. A probe as claimed in claim 1 wherein said optical fiber has a fiber length, said probe further comprising a plurality of sensing regions, said sensing regions being responsive primarily to different parameters and arranged at axially spaced locations along the fiber length.

10. A probe as claimed in claim 1 comprising a tubular housing, wherein the housing contains therewithin a portion of the optical fiber, and wherein the housing is arranged such that the fiber, in the sensing region(s) thereof, is exposed to the parameter to be measured.

11. A probe as claimed in claim 10 having two or more fibers arranged side-by-side within the housing, wherein the fibers have respective sensing regions which are responsive to different parameters or measurands.

12. A probe as claimed in claim 10 wherein the housing is filled with a liquid or gel such that one or more parameters to be measured are transferred to the one or more sensing regions of the fiber or fibers within the housing.

13. A probe as claimed in claim 12 wherein one or more of said parameters transferred by the liquid is selected from the group comprising temperature, pressure and biological or chemical substances which can diffuse through the liquid or gel.

14. A probe as claimed in claim 12 wherein the housing is filled with a liquid or gel such that a pressure applied to the housing is transmitted to the surface of a pressure sensitive region of the optical fiber within the housing.

15. A probe as claimed in claim 12 wherein the housing includes one or more apertures covered by a flexible membrane, through which external pressure is transmitted to the liquid or gel and thereby applied to the optical fiber.

16. A probe as claimed in claim 1 for measuring a biological or chemical parameter comprising a tubular housing filed with liquid or gel wherein the liquid or gel within the housing provides a transfer medium to enable particular target molecules to diffuse through the liquid and thereby be transferred to one or more optical fibers located within the housing, such fiber(s) having a suitable reactive sensing element coupled to the fiber providing a change in optical response.

17. A probe as claimed in claim 1 including a sealed tubular housing comprising a liquid or flowable gel disposed within the housing and surrounding the at least one fiber, the liquid or gel permitting the transfer of at least one parameter to be measured from a region outside the housing to the at least one sensing region of the fiber.

18. A probe as claimed in claim 17 the housing including one or more apertures covered by a membrane, the membrane allowing the application of pressure to the liquid or gel from the surrounding environment and/or allowing the selective diffusion of target molecules through the membrane.

19. A probe as claimed in claim 12 wherein the liquid is isotonic saline.

20. A probe as claimed in claim 10 including a temperature sensing region within one or more of the optical fibers and wherein the housing is formed of a material of good thermal conductivity.

21. A probe as claimed in claim 1 wherein one of the parameters to be detected is fluid pressure in the body and wherein the optical fiber is configured in at least one sensing region to provide a changing optical property depending on the pressure applied to the fiber.

22. A probe as claimed in claim 1 wherein the optical properties are spectral peaks or troughs at different wavelengths, said different wavelengths undergoing respective wavelength shifts in use in response to different parameters within the body.

23. A probe as claimed in claim 1 wherein one optical property of the sensor probe is the absolute wavelength of one or more spectral peaks of the fiber's optical response, and a further optical property is the spacing between spectral peaks or troughs in the mutually orthogonal polarization planes of the fiber.

24. A probe as claimed in claim 1 wherein the at least one sensing region comprises a sensing element formed of a material which undergoes a change in volume upon exposure to a parameter or measurand to be measured, such change in volume creating a strain within the fiber whereby a detectable change in optical response is obtained.

25. A probe as claimed in claim 1 wherein the optical fiber is birefringent.

26. A probe as claimed in claim 25 wherein the fiber comprises one or more side holes at the sensing region.

27. A probe as claimed in claim 26 wherein a sensing element is provided in said side hole said sensing element being arranged to swell when exposed to a measurand.

28. A probe as claimed in claim 25 comprising a birefringent fiber wherein the strain established in the fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

29. A probe as claimed in claim 1 wherein the sensing region comprises a sensing element including a coating of reactive material provided on the fiber.

30. A probe as claimed in claim 29 wherein the coating is configured to apply longitudinal and/or radial strain to the fiber when exposed to a measurand.

31. A probe as claimed in claim 1 wherein the sensing region comprises a sensing element including a piston and cylinder arrangement and wherein the sensing element is configured to expand and provide a longitudinal strain within the fiber when exposed to a measurand.

32. A probe as claimed in claim 1 wherein the sensing region comprises a material reactive to one or more of non-ionizing radiation, ionizing radiation and chemical or biological, including immunological, interactions.

33. A probe as claimed in claim 1 wherein the sensing region comprises a reactive material immobilized on a solid support medium.

34. A probe as claimed in claim 33 wherein the immobilization method is mechanical, electrostatic or chemical.

35. A probe as claimed in claim 33 or 34 wherein the solid support medium is a polymer, a copolymer, a glass.

36. A probe as claimed in claim 33 wherein the support medium is inert to the measurand being analysed.

37. A probe as claimed in claim 33 wherein the support itself acts as a selective element.

38. A probe as claimed in claim 37 wherein the support is selective through controlled porosity.

39. A probe as claimed in claim 1 wherein one or more than one of the sensing regions comprises a material immobilized in a fluid or gel, wherein the fluid or gel is arranged to swell or to contract in response to a target measurand.

40. A probe as claimed in claim 1 wherein a separate body compatible membrane is provided to cover or enclose the sensing region.

41. A probe as claimed in claim 40 wherein the membrane is arranged to select the measurand species based on one of size selectivity through controlled porosity of the membrane, chemical/biochemical selectivity through chemical reactions, or ionic selectivity through electrostatic interactions.

42. A probe as claimed in claim 1 wherein the sensing region comprises a coating of paint or bonding material such as a polymer gel network.

43. A probe as claimed in claim 42 wherein the sensing region is or comprises a biochemical key-lock pair, such as biotin-avidin or lectin-saccharide.

44. A probe as claimed in claim 1 wherein the sensing region comprises a coating of a porous material such as sol-gel glass or ceramics.

45. A probe as claimed in claim 1 wherein the sensing region comprises micro-spherical balls, provided with additives arranged to generate chemical selectivity for a selected group of molecules.

46. A probe as claimed in claim 1 wherein the sensing region comprises ionic N-Isopropylacrylamide (NIPA) polymer gel copolymerised by sodium acrylate (SA).

47. A probe as claimed in claim 1 wherein the sensing region is or comprises a hydrogel.

48. A probe as claimed in claim 1 comprising a tubular housing mounting therewithin in side-by-side arrangement two or more optical fibers, at least one of such fibers being provided with a sensing element responsive to a first parameter to be measured, and another fiber being absent such first sensing element, or provided with a second sensing element to detect a second parameter different from the first.

49. A probe as claimed in claim 48 wherein the second fiber is absent the sensing element, and wherein the optical response from said second fiber is used to correct the output from the first fiber provided with said sensing element.

50. A probe as claimed in claim 1 comprising a tubular housing mounting therewith optical fibers in side-by-side relation, a first fiber arranged to provide a birefringent response dependent on pressure applied to the fiber, and a second fiber arranged to provide a temperature dependent response which is used to correct measurements based on the optical output of said first fiber.

51. A probe as claimed in claim 1 comprising three fibers extending along a probe housing wherein a first fiber has at least one pressure sensitive region provided with a reactive coating; a second fiber has at least one pressure sensitive region but not provided with said reactive coating; and the third fiber is sensitive to temperature and/or longitudinal strain.

52. A probe as claimed in claim 1 comprising a plurality of fibers each having a distal end, the distal ends of said fibers being connected via a fiber minibend.

53. A probe as claimed in claim 1 wherein the optical fiber or fibers are located in a body compatible protective housing.

54. A fiber optic sensor device comprising a housing mounting therewithin at least two optical fibers mounted side-by-side, the fibers including respective sensing regions responsive primarily to respective different parameters to be measured.

55. A probe as claimed in claim 54 wherein at least one of the respective sensing regions comprises a mass of reactive material configured to create mechanical strain within the fiber in such a way as to change its optical response.

56. A probe as claimed in claim 54 wherein said two optical fibers each have an optical fiber core, at least one of said fibers comprising one or more fiber Bragg gratings (FBG's) written into the optical fiber core.

57. A probe as claimed in claim 54 comprising an active fiber laser including at least one of said fibers.

58. A fiber optic sensor device comprising a housing mounting therewithin at least two optical fibers mounted side-by-side, the fibers including respective sensing regions responsive primarily to respective different parameters to be measured, at least one of said optical fibers further comprising a pair of pi phase-shifted fiber Bragg gratings.

59. A probe as claimed in claim 54 wherein the fibers each have a fiber length, at least one of said fibers being provided with sensing regions responsive primarily to different parameters at axially spaced locations along the fiber length.

60. A probe as claimed in claim 54 wherein the probe is configured to measure first and second parameters, quantify said first parameter and use the measurement of the second parameter to correct the measurement of the first parameter.

61. A probe as claimed in claim 54 having a first optical property which changes in accordance with a first parameter, and a second optical property different from the first which changes in accordance with a second parameter, such that through the use of a suitable interrogation system said first and second parameters can be measured independently.

62. A probe as claimed in claim 54 wherein the housing is filled with a liquid or gel such that one or more parameters to be measured are transferred to the one or more sensing regions of the fiber or fibers within the housing.

63. A probe as claimed in claim 62 wherein one or more of said parameters transferred by the liquid is selected from the group comprising temperature, pressure and biological or chemical substances which can diffuse through the liquid or gel.

64. A probe as claimed in claim 54 wherein the housing is filled with a liquid or gel such that a pressure applied to the housing is transmitted to the surface of a pressure sensitive region of the optical fiber within the housing.

65. A probe as claimed in claim 62 wherein the housing includes one or more apertures covered by a flexible membrane, through which external pressure is transmitted to the liquid or gel and thereby applied to the optical fiber.

66. A probe as claimed in claim 54 for measuring a biological or chemical parameter wherein the housing is filled with liquid or gel and wherein the liquid or gel within the housing provides a transfer medium to enable particular target molecules to diffuse through the liquid and thereby be transferred to one or more optical fibers located within the housing, such fiber(s) having a suitable reactive sensing element coupled to the fiber providing a change in optical response.

67. A probe as claimed in claim 54 wherein the housing comprises a liquid or flowable gel disposed within the housing and surrounding the fibers, the liquid or gel permitting the transfer of at least one parameter to be measured from a region outside the housing to at least one of the sensing regions of the fiber.

68. A probe as claimed in claim 67 the housing including one or more apertures covered by a membrane, the membrane allowing the application of pressure to the liquid or gel from the surrounding environment and/or allowing the selective diffusion of target molecules through the membrane.

69. A probe as claimed in claim 62 wherein the liquid is isotonic saline.

70. A probe as claimed in claim 54 including a temperature sensing region within one or more of the optical fibers and wherein the housing is formed of a material of good thermal conductivity.

71. A probe as claimed in claim 54 wherein one of the parameters to be detected is fluid pressure in the body and wherein at least one of the optical fibers is configured in at least one sensing region to provide a changing optical property depending on the pressure applied to the fiber.

72. A probe as claimed in claim 54 wherein said different parameters are measurable through different optical properties, the optical properties being spectral peaks or troughs at different wavelengths, said different wavelengths undergoing respective wavelength shifts in use in response to said different parameters..

73. A probe as claimed in claim 54 wherein said different parameters are measurable through different optical properties, one of said optical properties being the absolute wavelength of one or more spectral peaks of the fiber's optical response, and a further optical property being the spacing between spectral peaks or troughs in the mutually orthogonal polarization planes of the fiber.

74. A probe as claimed in claim 54 wherein at least one of the sensing regions comprises a sensing element formed of a material which undergoes a change in volume upon exposure to a parameter or measurand to be measured, such change in volume creating a strain within the fiber whereby a detectable change in optical response is obtained.

75. A probe as claimed in claim 54 wherein at least one of the optical fibers is birefringent.

76. A probe as claimed in claim 75 wherein the fiber comprises one or more side holes at the sensing region.

77. A probe as claimed in claim 76 wherein a sensing element is provided in said side hole said sensing element being arranged to swell when exposed to a measurand.

78. A probe as claimed in claim 75 comprising a birefringent fiber wherein the strain established in the fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

79. A probe as claimed in claim 54 wherein at least one of the sensing regions comprises a sensing element including a coating of reactive material provided on the fiber.

80. A probe as claimed in claim 79 wherein the coating is configured to apply longitudinal and/or radial strain to the fiber when exposed to a measurand.

81. A probe as claimed in claim 54 wherein at least one of the sensing regions comprises a sensing element including a piston and cylinder arrangement and wherein the sensing element is configured to expand and provide a longitudinal strain within the fiber when exposed to a measurand.

82. A probe as claimed in claim 54 wherein at least one of the sensing regions comprises a material reactive to one or more of non-ionizing radiation, ionizing radiation and chemical or biological, including immunological, interactions.

83. A probe as claimed in claim 54 wherein at least one of the sensing regions comprises a reactive material immobilized on a solid support medium.

84. A probe as claimed in claim 83 wherein the support itself acts as a selective element.

85. A probe as claimed in claim 54 wherein one or more than one of the sensing regions comprises a material immobilized in a fluid or gel, wherein the fluid or gel is arranged to swell or to contract in response to a target measurand.

86. A probe as claimed in claim 54 wherein a separate body compatible membrane is provided to cover or enclose at least one of the sensing regions.

87. A probe as claimed in claim 86 wherein the membrane is arranged to select the measurand species based on one of size selectivity through controlled porosity of the membrane, chemical/biochemical selectivity through chemical reactions, or ionic selectivity through electrostatic interactions.

88. A probe as claimed in claim 54 wherein at least one of the sensing regions comprises a coating of paint or bonding material such as a polymer gel network.

89. A probe as claimed in claim 88 wherein at least one of the sensing regions is or comprises a biochemical key-lock pair, such as biotin-avidin or lectin-saccharide.

90. A probe as claimed in claim 54 wherein at least one of the sensing regions comprises a coating of a porous material such as sol-gel glass or ceramics.

91. A probe as claimed in claim 54 wherein at least one of the sensing regions comprises micro-spherical balls, provided with additives arranged to generate chemical selectivity for a selected group of molecules.

92. A probe as claimed in claim 54 wherein at least one of the sensing regions comprises ionic N-Isopropylacrylamide (NIPA) polymer gel copolymerised by sodium acrylate (SA).

93. A probe as claimed in claim 54 wherein the sensing region is or comprises a hydrogel.

94. A probe as claimed in claim 54 wherein a first one of the fibers comprises a sensing element and wherein the second fiber is absent the sensing element, and wherein the optical response from said second fiber is used to correct the output from the first fiber provided with said sensing element.

95. A probe as claimed in claim 54 wherein said fibers each have a distal end, the distal ends of said fibers being connected via a fiber minibend.

96. A probe as claimed in claim 54 wherein the optical fibers are located in a body compatible protective housing.

97. A body compatible fiber optic sensor probe for invasive medical use, provided with at least one optical fiber having axially spaced sensing regions, the sensing regions providing in use distinguishable optical responses or outputs dependent primarily on different parameters within the body.

98. A probe as claimed in claim 97 wherein at least one of the sensing regions comprises a mass of reactive material configured to create mechanical strain within the fiber in such a way as to change its optical response.

99. A probe as claimed in claim 97 comprising one or more fiber Bragg gratings (FBG's) written into the optical fiber core.

100. A probe as claimed in claim 97 comprising an active fiber laser including said fiber.

101. A body compatible fiber optic sensor probe for invasive medical use, provided with at least one optical fiber having axially spaced sensing regions, the sensing regions providing in use distinguishable optical responses or outputs dependent primarily on different parameters within the body said fiber further comprising a pair of pi phase-shifted fiber Bragg gratings.

102. A probe as claimed in claim 97 wherein the probe is configured to measure first and second parameters, quantify said first parameter and use the measurement of the second parameter to correct the measurement of the first parameter.

103. A probe as claimed in claim 97 comprising a tubular housing, wherein the housing contains therewithin a portion of the optical fiber, and wherein the housing is arranged such that the fiber, in the sensing regions thereof, is exposed to the parameters to be measured.

104. A probe as claimed in claim 103 having two or more fibers arranged side-by-side within the housing, wherein the fibers have respective sensing regions which are responsive to different parameters or measurands.

105. A probe as claimed in claim 103 wherein the housing is filled with a liquid or gel such that one or more parameters to be measured are transferred to the one or more sensing regions of the fiber or fibers within the housing.

106. A probe as claimed in claim 103 wherein one or more of said parameters transferred by the liquid is selected from the group comprising temperature, pressure and biological or chemical substances which can diffuse through the liquid or gel.

107. A probe as claimed in claim 105 wherein a pressure applied to the housing is transmitted to the surface of a pressure sensitive region of the optical fiber within the housing.

108. A probe as claimed in claim 107 wherein the housing includes one or more apertures covered by a flexible membrane, through which external pressure is transmitted to the liquid or gel and thereby applied to the optical fiber.

109. A probe as claimed in claim 97 for measuring a biological or chemical parameter comprising a tubular housing filled with liquid or gel wherein the liquid or gel within the housing provides a transfer medium to enable particular target molecules to diffuse through the liquid and thereby be transferred to one or more optical fibers located within the housing, such fiber(s) having a suitable reactive sensing element coupled to the fiber providing a change in optical response.

110. A probe as claimed in claim 97 including a sealed tubular housing comprising a liquid or flowable gel disposed within the housing and surrounding the fiber, the liquid or gel permitting the transfer of at least one parameter to be measured from a region outside the housing to the at least one sensing region of the fiber.

111. A probe as claimed in claim 110 wherein said housing includes one or more apertures covered by a membrane, the membrane allowing the application of pressure to the liquid or gel from the surrounding environment and/or allowing the selective diffusion of target molecules through the membrane.

112. A probe as claimed in claim 105 wherein the liquid is isotonic saline.

113. A probe as claimed in claim 103 including a temperature sensing region within one or more of the optical fibers and wherein the housing is formed of a material of good thermal conductivity.

114. A probe as claimed in claim 97 wherein one of the parameters to be detected is fluid pressure in the body and wherein the optical fiber is configured in at least one sensing region to provide a changing optical property depending on the pressure applied to the fiber.

115. A probe as claimed in claim 97 wherein the optical properties are spectral peaks or troughs at different wavelengths, said different wavelengths undergoing respective wavelength shifts in use in response to different parameters within the body.

116. A probe as claimed in claim 97 wherein one optical property of the sensor probe is the absolute wavelength of one or more spectral peaks of the fiber's optical response, and a further optical property is the spacing between spectral peaks or troughs in the mutually orthogonal polarization planes of the fiber.

117. A probe as claimed in claim 97 wherein at least one of the sensing regions comprises a sensing element formed of a material which undergoes a change in volume upon exposure to a parameter or measurand to be measured, such change in volume creating a strain within the fiber whereby a detectable change in optical response is obtained.

118. A probe as claimed in claim 97 wherein the optical fiber is birefringent.

119. A probe as claimed in claim 118 wherein the fiber comprises one or more side holes at the sensing region.

120. A probe as claimed in claim 119 wherein a sensing element is provided in said side hole said sensing element being arranged to swell when exposed to a measurand.

121. A probe as claimed in claim 97 wherein the fiber is birefringent and wherein a strain established in the fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

122. A probe as claimed in claim 97 wherein at least one of the sensing regions comprises a sensing element including a coating of reactive material provided on the fiber.

123. A probe as claimed in claim 122 wherein the coating is configured to apply longitudinal and/or radial strain to the fiber when exposed to a measurand.

124. A probe as claimed in claim 97 wherein at least one of the sensing regions comprises a sensing element including a piston and cylinder arrangement and wherein the sensing element is configured to expand and provide a longitudinal strain within the fiber when exposed to a measurand.

125. A probe as claimed in claim 97 wherein at least one of the sensing regions comprises a material reactive to one or more of non-ionizing radiation, ionizing radiation and chemical or biological, including immunological, interactions.

126. A probe as claimed in claim 97 wherein at least one of the sensing regions comprises a reactive material immobilized on a solid support medium.

127. A probe as claimed in claim 126 wherein the support itself acts as a selective element.

128. A probe as claimed in claim 97 wherein one or more than one of the sensing regions comprises a material immobilized in a fluid or gel, wherein the fluid or gel is arranged to swell or to contract in response to a target measurand.

129. A probe as claimed in claim 97 wherein a separate body compatible membrane is provided to cover or enclose at least one of the sensing regions.

130. A probe as claimed in claim 129 wherein the membrane is arranged to select the measurand species based on one of size selectivity through controlled porosity of the membrane, chemical/biochemical selectivity through chemical reactions, or ionic selectivity through electrostatic interactions.

131. A probe as claimed in claim 97 wherein at least one of the sensing regions comprises a coating of paint or bonding material such as a polymer gel network.

132. A probe as claimed in claim 131 wherein at least one of the sensing regions is or comprises a biochemical key-lock pair, such as biotin-avidin or lectin-saccharide.

133. A probe as claimed in claim 97 wherein at least one of the sensing regions comprises a coating of a porous material such as sol-gel glass or ceramics.

134. A probe as claimed in claim 97 wherein at least one of the sensing regions comprises micro-spherical balls, provided with additives arranged to generate chemical selectivity for a selected group of molecules.

135. A probe as claimed in claim 97 wherein at least one of the sensing regions comprises ionic N-Isopropylacrylamide (NIPA) polymer gel copolymerised by sodium acrylate (SA).

136. A probe as claimed in claim 97 wherein at least one of the sensing regions is or comprises a hydrogel.

137. A probe as claimed in claim 97 comprising three fibers extending along a probe housing wherein a first fiber has at least one pressure sensitive region provided with a reactive coating; a second fiber has at least one pressure sensitive region but not provided with said reactive coating; and the third fiber is sensitive to temperature and/or longitudinal strain.

138. A probe as claimed in claim 97 comprising a plurality of fibers each having a distal end, the distal ends of said fibers being connected via a fiber minibend.

139. A probe as claimed in claim 97 wherein the optical fiber or fibers are located in a body compatible protective housing.

140. An optical fiber sensor device including a sealed tubular housing containing therewithin at least one optical fiber having at least one sensing region, there being a liquid or flowable gel disposed within the housing and surrounding the fiber, the liquid or gel permitting the transfer of at least one parameter to be measured from a region outside the housing to a sensing region of the fiber.

141. An optical fiber sensor device including a sealed tubular housing containing therewithin at least one optical fiber having at least one sensing region, there being a liquid or flowable gel disposed within the housing and surrounding the fiber, the liquid or gel permitting the transfer of at least one parameter to be measured from a region outside the housing to a sensing region of the fiber, the at least one sensing region comprising a mass of reactive material configured to create mechanical strain within the fiber in such a way as to change its optical response.

142. A probe as claimed in claim 140 comprising one or more fiber Bragg gratings (FBG's) written into the optical fiber core.

143. A probe as claimed in claim 140 comprising an active fiber laser including said fiber.

144. An optical fiber sensor device including a sealed tubular housing containing therewithin at least one optical fiber having at least one sensing region, there being a liquid or flowable gel disposed within the housing and surrounding the fiber, the liquid or gel permitting the transfer of at least one parameter to be measured from a region outside the housing to a sensing region of the fiber said fiber comprising a pair of pi phase-shifted fiber Bragg gratings.

145. A probe as claimed in claim 140 wherein the fiber has a fiber length, said fiber being provided with sensing regions responsive primarily to different parameters at axially spaced locations along the fiber length.

146. A probe as claimed in claim 140 wherein the probe is configured to measure first and second parameters, quantify said first parameter and use the measurement of the second parameter to correct the measurement of the first parameter.

147. A probe as claimed in claim 140 having a first optical property which changes in accordance with a first parameter, and a second optical property different from the first which changes in accordance with a second parameter, such that through the use of a suitable interrogation system said first and second parameters can be measured independently.

148. A probe as claimed in claim 140 having two or more fibers each having a fiber length, at least one of said fibers having sensing regions responsive primarily to different parameters and arranged at axially spaced locations along the fiber length.

149. A probe as claimed in claim 140 having two or more fibers arranged side-by-side within the housing, wherein the fibers have respective sensing regions which are responsive to different parameters or measurands.

150. A probe as claimed in claim 140 wherein one or more of said parameters transferred by the liquid is selected from the group comprising temperature, pressure and biological or chemical substances which can diffuse through the liquid or gel.

151. A probe as claimed in claim 140 wherein the housing includes one or more apertures covered by a flexible membrane, through which external pressure is transmitted to the liquid or gel and thereby applied to the optical fiber.

152. A probe as claimed in claim 140 for measuring a biological or chemical parameter wherein the liquid or gel within the housing provides a transfer medium to enable particular target molecules to diffuse through the liquid and thereby be transferred to one or more optical fibers located within the housing, such fiber(s) having a suitable reactive sensing element coupled to the fiber providing a change in optical response.

153. A probe as claimed in claim 152 the housing including one or more apertures covered by a membrane, the membrane allowing the application of pressure to the liquid or gel from the surrounding environment and/or allowing the selective diffusion of target molecules through the membrane.

154. A probe as claimed in claim 140 wherein the liquid is isotonic saline.

155. A probe as claimed in claim 140 including a temperature sensing region within one or more of the optical fibers and wherein the housing is formed of a material of good thermal conductivity.

156. A probe as claimed in claim 140 wherein one of the parameters to be detected is fluid pressure in the body and wherein the optical fiber is configured in at least one of the sensing regions to provide a changing optical property depending on the pressure applied to the fiber.

157. A probe as claimed in claim 140 wherein at least one of the sensing regions comprises a sensing element formed of a material which undergoes a change in volume upon exposure to a parameter or measurand to be measured, such change in volume creating a strain within the fiber whereby a detectable change in optical response is obtained.

158. A probe as claimed in claim 140 wherein the optical fiber is birefringent.

159. A probe as claimed in claim 158 wherein the fiber comprises one or more side holes at the sensing region.

160. A probe as claimed in claim 159 wherein a sensing element is provided in said side hole said sensing element being arranged to swell when exposed to a measurand.

161. A probe as claimed in claim 157 wherein the fiber is birefringent fiber and wherein a strain established in the fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

162. A probe as claimed in claim 140 wherein the sensing region comprises a sensing element including a coating of reactive material provided on the fiber.

163. A probe as claimed in claim 162 wherein the coating is configured to apply longitudinal and/or radial strain to the fiber when exposed to a measurand.

164. A probe as claimed in claim 140 wherein the sensing region comprises a material reactive to one or more of non-ionizing radiation, ionizing radiation and chemical or biological, including immunological, interactions.

165. A probe as claimed in claim 140 wherein the sensing region comprises a reactive material immobilized on a solid support medium.

166. A probe as claimed in claim 165 wherein the support itself acts as a selective element.

167. A probe as claimed in claim 140 wherein a separate body compatible membrane is provided to cover or enclose the sensing region.

168. A probe as claimed in claim 167 wherein the membrane is arranged to select the measurand species based on one of size selectivity through controlled porosity of the membrane, chemical/biochemical selectivity through chemical reactions, or ionic selectivity through electrostatic interactions.

169. A probe as claimed in claim 140 wherein the sensing region comprises a coating of paint or bonding material such as a polymer gel network.

170. A probe as claimed in claim 168 wherein the sensing region is or comprises a biochemical key-lock pair, such as biotin-avidin or lectin-saccharide.

171. A probe as claimed in claim 140 wherein the sensing region comprises a coating of a porous material such as sol-gel glass or ceramics.

172. A probe as claimed in claim 140 wherein the sensing region comprises micro-spherical balls, provided with additives arranged to generate chemical selectivity for a selected group of molecules.

173. A probe as claimed in claim 140 wherein the sensing region comprises ionic N-Isopropylacrylamide (NIPA) polymer gel copolymerised by sodium acrylate (SA).

174. A probe as claimed in claim 140 wherein the sensing region is or comprises a hydrogel.

175. A probe as claimed in claim 140 comprising within the tubular housing in side-by-side arrangement two or more optical fibers, at least one of such fibers being provided with a sensing element responsive to a first parameter to be measured, and another fiber being absent such first sensing element, or provided with a second sensing element to detect a second parameter different from the first.

176. A probe as claimed in claim 175 wherein the second fiber is absent the sensing element, and wherein the optical response from said second fiber is used to correct the output from the first fiber provided with said sensing element.

177. A probe as claimed in claim 140 comprising a tubular housing mounting therewith optical fibers in side-by-side relation, a first fiber arranged to provide a birefringent response dependent on pressure applied to the fiber, and a second fiber arranged to provide a temperature dependent response which is used to correct measurements based on the optical output of said first fiber.

178. A probe as claimed in claim 140 wherein the optical fiber or fibers are located in a body compatible protective housing.

179. A fiber optic sensor device comprising a tubular housing mounting therewith optical fibers in side-by-side relation, a first fiber providing a birefringent response dependent on pressure applied to the fiber, and the second fiber providing a temperature dependent response which may be used to correct measurements based on the optical output of the first fiber.

180. A probe as claimed in claim 179 comprising one or more fiber Bragg gratings (FBG's) written into the optical fiber core of at least one of said first or second optical fibers.

181. A probe as claimed in claim 179 comprising an active fiber laser including at least one of said fibers.

182. A probe as claimed in claim 179 wherein said first or second optical fibers comprises a pair of pi phase-shifted fiber Bragg gratings.

183. A probe as claimed in claim 10 wherein the housing is filled with a liquid or gel such that said temperature and pressure are transferred to one or more sensing regions of the first and second fibers within the housing.

184. A probe as claimed in claim 183 wherein the housing includes one or more apertures covered by a flexible membrane, through which external pressure is transmitted to the liquid or gel and thereby applied to the optical fiber.

185. A probe as claimed in claim 183 wherein the liquid is isotonic saline.

186. A probe as claimed in claim 179 wherein a strain is established in the first fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

187. A probe as claimed in claim 179 wherein a separate body compatible membrane is provided to cover or enclose a sensing region of the probe.

188. A probe as claimed in claim 179 wherein the optical fibers are located in a body compatible protective housing.

189. A fiber optic sensor device comprising three fibers extending along a probe housing wherein a first fiber has at least one pressure sensitive region provided with a reactive coating; a second fiber has at least one pressure sensitive region but not provided with the reactive coating; and the third fiber is sensitive to temperature and/or longitudinal strain.

190. A probe as claimed in claim 189 wherein at least one of the fibers comprises one or more fiber Bragg gratings (FBG's) written into the optical fiber core.

191. A probe as claimed in claim 189 wherein at least one of the fibers comprises an active fiber laser including said fiber.

192. A probe as claimed in claim 189 wherein at least one of the fibers comprises a pair of pi phase-shifted fiber Bragg gratings.

193. A probe as claimed in claim 189 wherein the housing is filled with a liquid or gel such that one or more parameters to be measured are transferred to the one or more sensing regions of the fiber or fibers within the housing.

194. A probe as claimed in claim 189 wherein the housing is filled with a liquid or gel such that a pressure applied to the housing is transmitted to the surface of a pressure sensitive region of the optical fiber within the housing.

195. A probe as claimed in claim 194 wherein the housing includes one or more apertures covered by a flexible membrane, through which external pressure is transmitted to the liquid or gel and thereby applied to the optical fiber.

196. A probe as claimed in claim 193 wherein the liquid is isotonic saline.

197. A probe as claimed in claim 189 wherein said first fiber comprises one or more side holes at a sensing region.

198. A probe as claimed in claim 189 wherein a strain is established in said first fiber, said strain being one of longitudinal strain, bending strain, and/or generally radially directed strain, such that there is a change both in an absolute wavelength of the optical response or output of the first fiber, and a change in a distance between spectral peaks in mutually orthogonal polarization planes.

199. A probe as claimed in claim 189 wherein the coating is configured to apply longitudinal and/or radial strain to the fiber when exposed to a measurand.

200. A probe as claimed in claim 189 wherein a separate body compatible membrane is provided to cover or enclose a sensing region of the probe.

201. A probe as claimed in claim 200 wherein the membrane is arranged to select the measurand species based on one of size selectivity through controlled porosity of the membrane, chemical/biochemical selectivity through chemical reactions, or ionic selectivity through electrostatic interactions.

202. A probe as claimed in claim 189 wherein the first fiber comprises a coating of paint or bonding material such as a polymer gel network.

203. A probe as claimed in claim 202 wherein the sensing region is or comprises a biochemical key-lock pair, such as biotin-avidin or lectin-saccharide.

204. A probe as claimed in claim 189 wherein the first fiber comprises a coating of a porous material such as sol-gel glass or ceramics.

205. A probe as claimed in claim 189 wherein the reactive coating region comprises micro-spherical balls, provided with additives arranged to generate chemical selectivity for a selected group of molecules.

206. A probe as claimed in claim 189 wherein the reactive coating comprises ionic N-Isopropylacrylamide (NIPA) polymer gel copolymerised by sodium acrylate (SA).

207. A probe as claimed in claim 189 wherein the reactive coating comprises a hydrogel.

208. A probe as claimed in claim 189 wherein said three fibers each have a distal end, the distal ends of said fibers are connected via a fiber minibend.

209. A probe as claimed in claim 189 wherein the optical fibers are located in a body compatible protective housing.

210. A fiber optic sensor device, comprising a fiber or fibers having respective sensing regions located within a sealed tubular housing wherein a liquid is interposed between said sensing regions and the wall of the housing, having a first sensing region primarily pressure dependent, and having a second sensing region primarily temperature dependent.

211. A probe as claimed in claim 210 wherein at least one of said fibers comprises one or more fiber Bragg gratings (FBG's) written into the optical fiber core.

212. A probe as claimed in claim 210 wherein at least one of said fibers comprises an active fiber laser including said fiber.

213. A probe as claimed in claim 210 wherein at least one of said fibers comprises a pair of pi phase-shifted fiber Bragg gratings.

214. A probe as claimed in claim 210 having a first optical property which changes in accordance with pressure, and a second optical property different from the first which changes in accordance with temperature, such that through the use of a suitable interrogation system pressure and temperature can be measured independently.

215. A probe as claimed in claim 210 having two or more fibers arranged side-by-side within the housing, wherein the fibers have respective sensing regions which are responsive to different parameters or measurands.

216. A probe as claimed in claim 210 wherein the liquid is isotonic saline.

217. A probe as claimed in claim 210 wherein at least one of said sensing regions comprises a sensing element formed of a material which undergoes a change in volume upon exposure to a parameter or measurand to be measured, such change in volume creating a strain within the fiber whereby a detectable change in optical response is obtained.

218. A probe as claimed in claim 210 wherein the optical fiber is birefringent.

219. A probe as claimed in claim 218 wherein the fiber comprises one or more side holes at the sensing region.

220. A probe as claimed in claim 210 comprising a birefringent fiber wherein the strain established in the fiber is one of longitudinal strain, bending strain, and/or generally radially directed strain, such that there is a change both in an absolute wavelength of the optical response or output of the fiber, and a change in a distance between spectral peaks in mutually orthogonal polarization planes.

221. A probe as claimed in claim 210 wherein a separate body compatible membrane is provided to cover or enclose a sensing region.

222. A probe as claimed in claim 210 comprising a plurality of fibers each having a distal end, the distal ends of said fibers being connected via a fiber minibend.

223. A probe as claimed in claim 210 wherein the optical fiber or fibers are located in a body compatible protective housing.

224. A method of medical or biological treatment, analysis or diagnosis, involving the use of one or more probes or sensors as claimed in claim 1.

225. A sterile pack including one or more probes as claimed in claim 1.

226. A method of medical treatment comprising the simultaneous sensing of different parameters within the body through the use a fiber optic probe having a sensing region or regions with measurable optical properties dependent on mechanical strain established in one or more optical fibers wherein the probe is responsive to at least two different parameters within the body.

227. A dual parameter fiber optic sensing system, comprising a pair of birefringent optical fibers each having at least one sensor configured to provide a birefringent optical output dependent upon a respective parameter, and detecting means having signal processing means adapted to provide an electrical output signal indicative of the birefringence of each of said fiber.
